(19) United States
(12) Patent Application Publication
(10) Pub. No.: US 2018/0265043 A1
(43) Pub. Date: Sep. 20, 2018

(54) PROXIMITY SWITCH AND HUMIDITY SENSOR ASSEMBLY

(71) Applicant: Ford Global Technologies, LLC, Dearborn, MI (US)

(72) Inventors: Stuart C. Salter, White Lake, MI (US); Pietro Buttolo, Dearborn Heights, MI (US); Manfred Koberstein, Troy, MI (US); Paul Kenneth Dellock, Northville, MI (US); William Stewart Johnston, South Lyon, MI (US); Todd Jared Konet, Canton, MI (US)

(73) Assignee: Ford Global Technologies, LLC

(21) Appl. No.: 15/458,290

(22) Filed: Mar. 14, 2017

(51) Int. Cl. B60S 1/02; G01D 5/24; G01N 27/22

(52) U.S. Cl. CPC B60S 1/026; G01N 27/223; G01D 5/24

(57) ABSTRACT

A proximity switch assembly with humidity sensing is provided that includes a proximity sensor providing an activation field and control circuitry monitoring a signal responsive to the activation field, determining a switch activation based on the signal, and determining a humidity value based on the signal.

### FIELD OF THE INVENTION

The present invention generally relates to proximity switches and sensors, and more particularly relates to proximity switches and humidity sensing on a vehicle.

### BACKGROUND OF THE INVENTION

Automotive vehicles are typically equipped with various user actuatable switches, such as switches for operating devices including powered windows, headlights, windshield wipers, moonroofs or sunroofs, interior lighting, radio and infotainment devices, and various other devices. Generally, these types of switches need to be actuated by a user in order to activate or deactivate a device or perform some type of control function. Proximity switches, such as capacitive switches, employ one or more proximity sensors to generate a sense activation field and sense changes to the activation field indicative of user actuation of the switch, typically caused by a user's finger in close proximity or contact with the sensor. Capacitive switches are typically configured to detect user actuation of the switch based on comparison of the sense activation field to a threshold.

Climate control systems employed on board vehicles may include a humidity sensor for sensing humidity or moisture in the air within the vehicle such as near the window glass. The humidity may cause moisture buildup on the window and the climate control system may respond to reduce moisture buildup. It may be desirable to provide for an enhanced proximity switch arrangement that reduces the need for a separate humidity sensor to detect humidity within the vehicle.

### SUMMARY OF THE INVENTION

According to one aspect of the present invention, a proximity switch assembly with humidity sensing is provided. The proximity switch assembly with humidity sensing includes a proximity switch comprising a proximity sensor providing an activation field. The proximity switch assembly also includes control circuitry monitoring a signal responsive to the activation field, determining a switch activation based on the signal, and determining a humidity value based on the signal.

Embodiments of the first aspect of the invention can include any one or a combination of the following features:
the control circuitry determines the switch activation based on a rate of change of the signal;
the switch activation is further determined based on an amplitude of the signal exceeding a touch threshold;
the humidity value is determined based on amplitude of the signal;
the humidity value is determined by comparing the amplitude of the signal to known humidity values in a look-up table;
the proximity switch is installed in a vehicle for use by a passenger of the vehicle;
control circuitry controls a window defogger on the vehicle to defog a window based on the humidity value;
the proximity sensor is located near the window;
the proximity switch comprises a capacitive switch comprising one or more capacitive sensors; and
the assembly comprises a plurality of proximity switches, each comprising a proximity sensor, wherein the control circuitry determines the humidity value based on signals generated by two or more proximity sensors; and the control circuitry determines the humidity value for each of the two or more proximity sensors and further determines an average humidity based on the humidity values for the two or more proximity sensors.

According to another aspect of the present invention, a vehicle switch and humidity sensing assembly is provided. The proximity switch and humidity sensing assembly includes a plurality of capacitive switches located on the vehicle, each comprising a capacitive sensor providing an activation field. The proximity switch and humidity sensing assembly also includes control circuitry monitoring a signal responsive to the activation field, determining a switch activation based on the signal, and determining a humidity value based on the signal.

Embodiments of the second aspect of the invention can include any one or a combination of the following features:
the control circuitry determines the switch activation based on a rate of change of the signal and an amplitude of the signal exceeding a touch threshold;
the humidity value is determined based on amplitude of the signal, and wherein the humidity value is determined by comparing the signal to known humidity values in a look-up table; and
the control circuitry determines the humidity value based on signals generated by two or more capacitive sensors, and wherein the control circuitry determines the humidity value for each of the two or more proximity sensors and further determines an average humidity based on the humidity values for the two or more proximity sensors.

According to a further aspect of the present invention, a method of detecting switch activation and humidity with a proximity switch is provided. The method includes the steps of generating an activation field with a proximity sensor, monitoring amplitude of a signal generated in response to the activation field, determining an activation of the switch based on the signal, and determining a humidity value based on the signal.

Embodiments of the third aspect of the invention can include any one or a combination of the following features:
the proximity switch is installed in a vehicle for use by a passenger of the vehicle;
the proximity switch comprises a capacitive switch comprising one or more capacitive sensors;
activation of the switch is determined based on the amplitude and a rate of change of the signal; and
the humidity value is determined based on amplitude of the signal compared to known humidity values in a look-up table.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective view of a passenger compartment of an automotive vehicle having an overhead console employing a proximity switch and humidity sensor assembly, according to one embodiment;

FIG. 2 is an enlarged view of the overhead console and proximity switch and humidity sensor assembly shown in FIG. 1;

FIG. 3 is an enlarged cross-sectional view taken through line in FIG. 2 showing an array of proximity switches in relation to a user's finger;

FIG. 4 is a schematic diagram of a capacitive sensor employed in each of the capacitive switches shown in FIG. 3;

FIG. 5 is a block diagram illustrating the proximity switch and humidity sensor assembly, according to one embodiment;

FIG. 6 is a graph illustrating the raw signal count for one signal channel associated with a capacitive sensor showing an activation motion profile;

FIG. 7 is a graph illustrating the raw signal count for one signal channel associated with the capacitive sensors showing the effect of humidity;

FIG. 8 is a graph illustrating the raw signal count for expected humidity readings;

FIG. 9 is a state diagram illustrating switch activation and humidity estimation states for the proximity switch and humidity sensor assembly; and

FIGS. 10A and 10B is a flow diagram illustrating a routine for sensing humidity within the vehicle and activating the proximity switch, according to one embodiment.

### DETAILED DESCRIPTION OF THE PREFERRED EMBODIMENTS

As required, detailed embodiments of the present invention are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

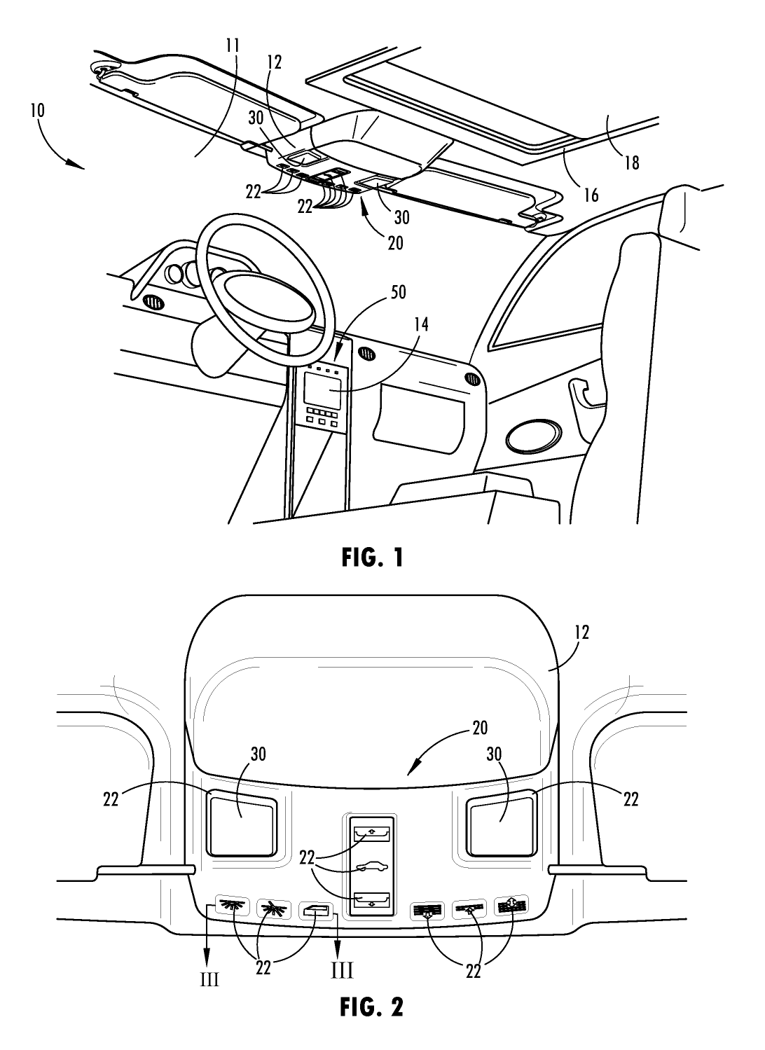

Referring to FIGS. 1 and 2, the interior of an automotive vehicle 10 is generally illustrated having a passenger compartment and a combination switch and humidity sensing assembly 20 employing a plurality of proximity switches 22 configured to sense switch activations and humidity, according to one embodiment. The vehicle 10 generally includes an overhead console 12 assembled to the headliner on the underside of the roof or ceiling at the top of the vehicle passenger compartment, generally above the front passenger seating area. The switch assembly 20 has a plurality of proximity switches 22 arranged close to one another in the overhead console 12, according to one embodiment. The overhead console is located rearward of and proximate to the vehicle windshield 11 and the assembly 20 may therefore sense humidity proximate to the inside surface of the windshield 11. The various proximity switches 22 may control any of a number of vehicle devices and functions, such as controlling movement of a sunroof or moonroof 16, controlling movement of a moonroof shade 18, controlling activation of one or more lighting devices such as interior map/reading and dome lights 30, and various other devices and functions. The interior map/reading and dome lights 30 may include proximity switches built into the lens or other component and having one or more proximity sensors for sensing a finger of a user and further sensing humidity. It should be appreciated that the proximity switches 22 may be located elsewhere on the vehicle 10, such as in the dash panel, on other consoles such as a center console, integrated into a touch screen display 14 for a radio or infotainment system such as a navigation and/or audio display, or located elsewhere onboard the vehicle 10 according to various vehicle applications.

The proximity switches 22 are shown and described herein as capacitive switches, according to one embodiment. Each proximity switch 22 includes at least one proximity sensor that provides a sense activation field to sense contact or close proximity (e.g., within one millimeter) of a user in relation to the one or more proximity sensors, such as a swiping motion by a user's finger. Thus, the sense activation field of each proximity switch 22 is a capacitive field in the exemplary embodiment and the user's finger has electrical conductivity and dielectric properties that cause a change or disturbance in the sense activation field as should be evident to those skilled in the art. In addition, one or more of the proximity sensors associated with one or more of the proximity switches 22 also senses humidity or moisture content. However, it should also be appreciated by those skilled in the art that additional or alternative types of proximity sensors can be used, such as, but not limited to, inductive sensors, infrared sensors, temperatures sensors, resistive sensors, the like, or a combination thereof. Exemplary proximity sensors are described in the Apr. 9, 2009, ATMEL® Touch Sensors Design Guide, 10620 D-AT42-04/09, the entire reference hereby being incorporated herein by reference.

The proximity switches 22 shown in FIGS. 1 and 2 each provide control of a vehicle component or device or provide a designated control function. One or more of the proximity switches 22 may be configured to control movement of a sunroof or moonroof 16 so as to cause the moonroof 16 to move in an open or closed direction, tilt the moonroof, or stop movement of the moonroof based upon a control algorithm. One or more other proximity switches 22 may be configured to control movement of a moonroof shade 18 between open and closed positions. Each of the moonroof 16 and shade 18 may be actuated by an electric motor in response to actuation of the corresponding proximity switch 22. Other proximity switches 22 may be configured to control other devices, such as turning an interior map/reading light 30 on, turning an interior map/reading light 30 off, turning a dome lamp on or off, unlocking a trunk, opening a rear hatch, or defeating a door light switch. Additional controls via the proximity switches 22 may include actuating door power windows up and down. Various other vehicle controls may be controlled by way of the proximity switches 22 described herein.

In addition, one or more of the proximity switches 22 is configured also to sense humidity. The humidity is sensed by a change in the signal generated by the proximity sensor due to the moisture content in the air. For example, when a vehicle door is opened in a high humidity environment, the increase in humidity entering the vehicle can be sensed by the increase in the proximity sensor signal. In one embodiment, a single proximity switch 22 may be configured sense humidity. According to another embodiment, a plurality of proximity switches 22 may be configured to sense humidity.

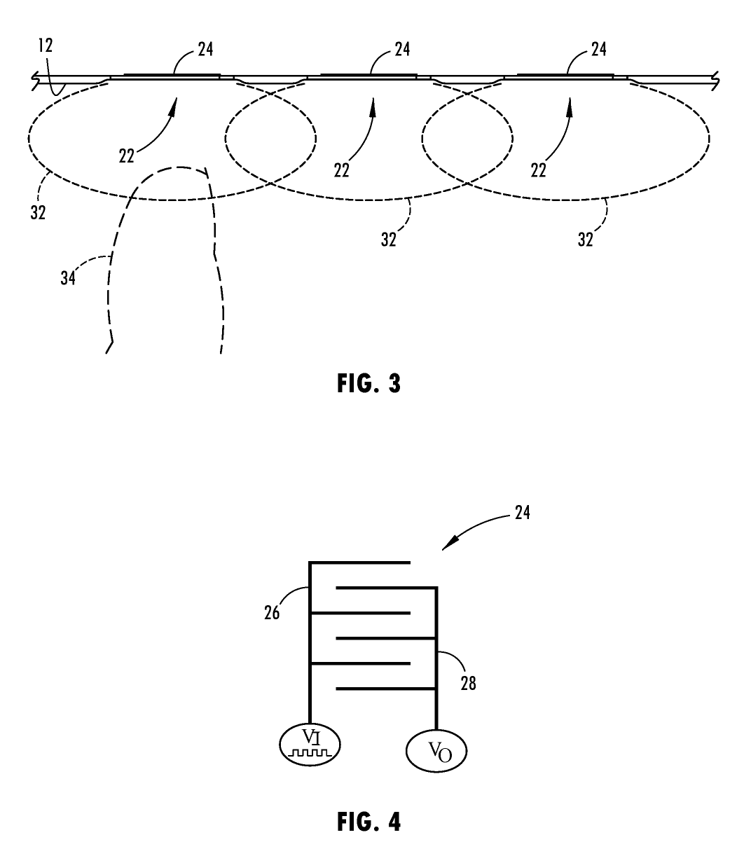

Referring to FIG. 3, a portion of the proximity switch assembly 20 is illustrated having an array of three serially arranged proximity switches 22 in close relation to one another in relation to a user's finger 34 during use of the switch assembly 20. Each proximity switch 22 includes one or more proximity sensors 24 for generating a sense activation field. According to one embodiment, each of the proximity sensors 24 may be formed by printing conductive ink onto the top surface of the polymeric overhead console 12. One example of a printed ink proximity sensor 24 is shown in FIG. 4 generally having a drive electrode 26 and a receive electrode 28 each having interdigitated fingers for generating a capacitive field 32. It should be appreciated that each of the proximity sensors 24 may be otherwise formed such as by assembling a preformed conductive circuit trace onto a substrate according to other embodiments. The drive electrode 26 receives square wave drive pulses applied at voltage V_{I}. The receive electrode 28 has an output for generating an output voltage V_{O}. It should be appreciated that the electrodes 26 and 28 may be arranged in various other configurations for generating the capacitive field as the activation field 32.

In the embodiment shown and described herein, the drive electrode 26 of each proximity sensor 24 is applied with voltage input V_{I} as square wave pulses having a charge pulse cycle sufficient to charge the receive electrode 28 to a desired voltage. The receive electrode 28 thereby serves as a measurement electrode. In the embodiment shown, adjacent sense activation fields 32 generated by adjacent proximity switches 22 overlap slightly, however, overlap may not exist according to other embodiments. When a user or operator, such as the user's finger 34, enters an activation field 32, the proximity switch assembly 20 detects the disturbance caused by the finger 34 to the activation field 32 and determines whether the disturbance is sufficient to activate the corresponding proximity switch 22. The disturbance of the activation field 32 is detected by processing the charge pulse signal associated with the corresponding signal channel. When the user's finger 34 contacts two activation fields 32, the proximity switch assembly 20 detects the disturbance of both contacted activation fields 32 via separate signal channels. Each proximity switch 22 has its own dedicated signal channel generating charge pulse counts which is processed as discussed herein.

In addition to sensing an activation of the proximity switch 22, the switch assembly 20 also detects the humidity with the use of one or more proximity sensors 24 associated with one or more of the proximity switches 22. The proximity sensor 24, configured as a capacitive sensor in the embodiment shown and described herein, is sensitive to moisture which affects the sensor activation field similar to a touch by a user's finger. Unlike a typical touch activation which causes a rather fast rise in the signal count, humidity or moisture content will cause the signal to rise at a slower rate. For example, when someone opens a vehicle door and the humidity rises due to the change in the environmental conditions, the humidity may be detected by monitoring the change in the activation signal in relation to a look-up table. Thus, activations by a user's finger can be distinguished from the humidity and the sensed signal can be used to generate a humidity value that may be used for other purposes on the vehicle such as by a climate control system to control a window defogger or other control device(s). In one embodiment, a single proximity sensor 24 may be used to determine the humidity. According to another embodiment, a plurality of proximity sensors 24 associated with a plurality of proximity switches 22 may be employed to generate multiple humidity signals which may be averaged to provide an average humidity measurement.

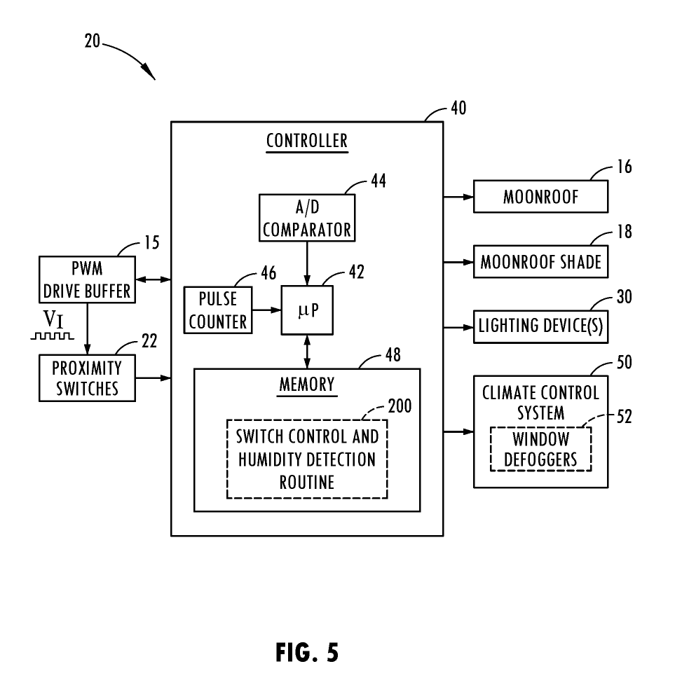

Referring to FIG. 5, the proximity switch assembly 20 is illustrated according to one embodiment. A plurality of proximity sensors 24 are shown providing inputs to a controller 40, such as a microcontroller. The controller 40 may include control circuitry, such as a microprocessor 42 and memory 48. The control circuitry may include sense control circuitry processing the activation field of each proximity sensor 24 to sense user activation of the corresponding switch by comparing the activation field signal to one or more thresholds pursuant to one or more control routines. The control circuitry may also sense humidity detected by one or more proximity sensors 24 by comparing the activation field signal of one or more sensors to signal amplitude and rise time for the signal to rise pursuant to one or more humidity sensing routines, which may include the use of a look-up table that links raw signal data to known humidity levels. It should be appreciated that other analog and/or digital control circuitry may be employed to process each activation field, determine user activation, and initiate an action. The controller 40 may employ a QMatrix acquisition method available by ATMEL®, according to one embodiment. The ATMEL acquisition method employs a WINDOWS® host C/C++ compiler and debugger WinAVR to simplify development and testing the utility Hawkeye that allows monitoring in real-time the internal state of critical variables in the software as well as collecting logs of data for post-processing.

The controller 40 provides an output signal to one or more devices that are configured to perform dedicated actions responsive to activation of a proximity switch by user touch. For example, the one or more devices may include a moonroof 16 having a motor to move the moonroof panel between open and closed and tilt positions, a moonroof shade 18 that moves between open and closed positions, and lighting devices 30 that may be turned on and off. Other devices may be controlled such as a radio for performing on and off functions, volume control, scanning, and other types of devices for performing other dedicated functions. One of the proximity switches 22 may be dedicated to actuating the moonroof closed, another proximity switch 22 may be dedicated to actuating the moonroof open, and a further switch 22 may be dedicated to actuating the moonroof to a tilt position, all of which would cause a motor to move the moonroof to a desired position. The moonroof shade 18 may be opened in response to one proximity switch 22 and may be closed responsive to another proximity switch 22.

The controller 40 processes the signals generated by one or more proximity sensors and further generates an output signal indicative of the sensed humidity. The output humidity signal may be output to one or more control devices including one or more window defoggers 52 of the climate control system 50 for defogging the vehicle windshield 11 proximate to the proximity sensor(s) sensing the humidity or for defogging other windows on the vehicle. The sensed humidity signal may be used for other control devices, such as to control the HVAC on the vehicle and other applications. In addition, the sensed humidity signal may be used to adjust the sensitivity of the proximity switch activation to enhance the use of the proximity switches in varying humidity conditions. The controller 40 may execute one or more switch control and humidity detection routine 200. According to one embodiment, the assembly may sense humidity with a single proximity sensor. According to another embodiment, the assembly may sense humidity with a plurality of proximity sensors and may determine an average humidity measurement.

The controller 40 is further shown having an analog to digital (A/D) comparator 44 coupled to the microprocessor 42. The A/D comparator 44 receives the voltage output V_{O} from each of the proximity switches 22, converts the analog signal to a digital signal, and provides the digital signal to the microprocessor 42. Additionally, controller 40 includes a pulse counter 46 coupled to the microprocessor 42. The pulse counter 46 counts the charge signal pulses that are applied to each drive electrode of each proximity sensor, performs a count of the pulses needed to charge the capacitor until the voltage output V_{O} reaches a predetermined voltage, and provides the count to the microprocessor 42. The pulse count is indicative of the change in capacitance of the corresponding capacitive sensor. The controller 40 is further shown communicating with a pulse width modulated drive buffer 15. The controller 40 provides a pulse width modulated signal to the pulse width modulated drive buffer 15 to generate a square wave pulse train V_{I} which is applied to each drive electrode of each proximity sensor of switch 22. The controller 40 processes one or more control routine 200 stored in memory 48 to monitor and make a determination as to activation of one of the proximity switches. The controller 40 also processes the signals and determines a measurement of the humidity. The controller 40 outputs the humidity measurement value and may use the humidity measurement to control a windshield defogger or other features. The control routines may also include one or more routines for compensation of the proximity switch determination based on the detected humidity.

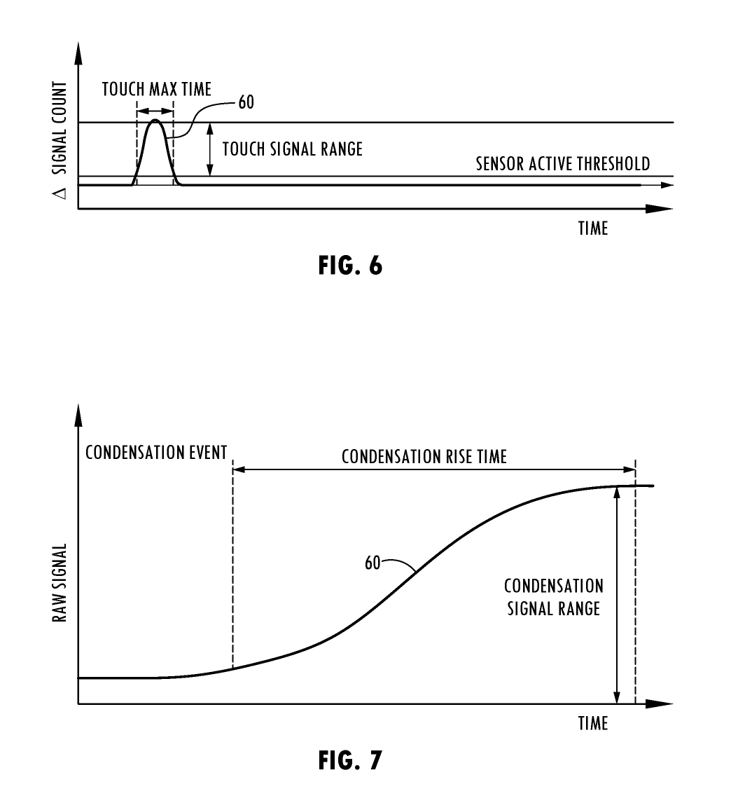

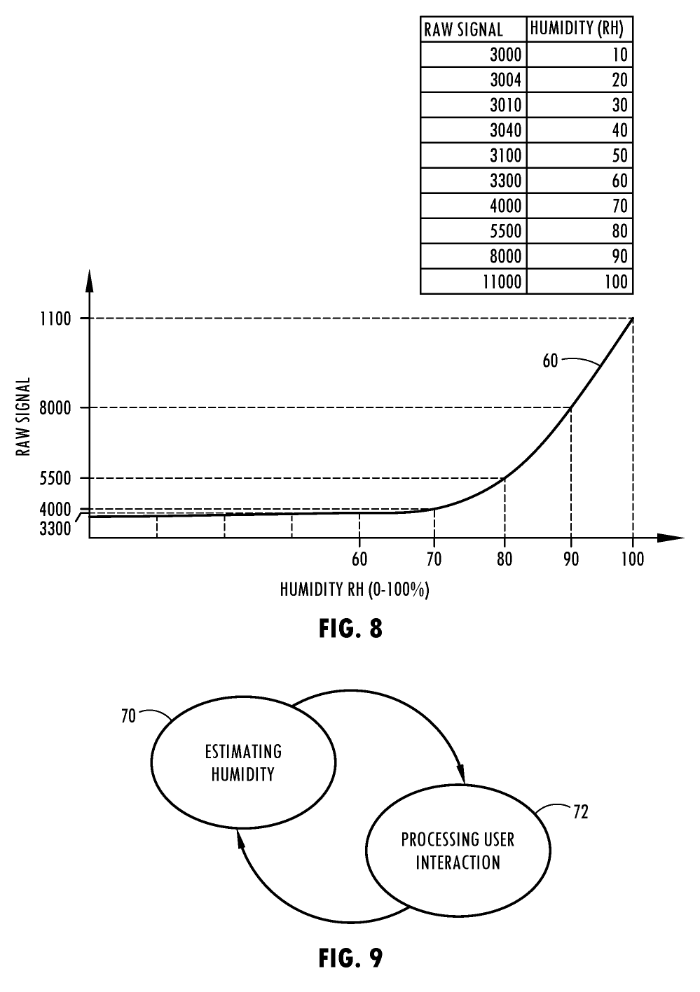

In FIGS. 6-8, the change in sensor charge pulse counts shown as signal count 60 for a signal channel associated with one of the plurality of proximity switches 22, is illustrated for a touch event in FIG. 6 and is shown as a raw signal for humidity detection in FIGS. 7 and 8, according to one example. The change in signal count 60 is the difference between an initialized referenced count value without any finger or other object present in the activation field and the corresponding sensor reading with low or no humidity. In the example shown in FIG. 6, the user's finger enters the activation field 32 associated with a proximity switch 22 as the user's finger moves across the switch. The signal 60 is the change (Δ) in sensor charge pulse count associated with a capacitive sensor 24. In the disclosed embodiment, the proximity sensors 24 are capacitive sensors. When a user's finger is in contact with or close proximity of a sensor 24, the finger alters the capacitance measured at the corresponding sensor 24. The capacitance is in parallel to the untouched sensor pad parasitic capacitance, and as such, measures as an offset. The user or operator induced capacitance is proportional to the user's finger or other body part dielectric constant, the surface exposed to the capacitive pad, and is inversely proportional to the distance of the user's limb to the switch button. According to one embodiment, each sensor is excited with a train of voltage pulses via pulse width modulation (PWM) electronics until the sensor is charged up to a set voltage potential. Such an acquisition method charges the receive electrode 28 to a known voltage potential. The cycle is repeated until the voltage across the measurement capacitor reaches a predetermined voltage. Placing a user's finger on the touch surface of the switch 24 introduces external capacitance that increases the amount of charge transferred each cycle, thereby reducing the total number of cycles required for the measurement capacitance to reach the predetermined voltage. The user's finger causes the change in sensor charge pulse count to increase since this value is based on the initialized reference count minus the sensor reading.

Referring to FIG. 6, as the user's finger 34 approaches a proximity switch 22 associated with the signal channel, the finger 34 enters the activation field 32 associated with the sensor 24 which causes disruption to the capacitance, thereby resulting in a sensor count increase as shown by signal 60 having a typical touch activation motion profile. During a typical user touch activation, the signal rises relatively quickly to exceed a sensor active threshold and then reaches a peak value and then drops back down below the sensor active threshold. A switch activation may be detected based on the signal exceeding a threshold value and/or based on a rise time of the signal.

Referring to FIG. 7, as condensation or moisture within the vehicle increases, such as when the vehicle door is opened and high humidity air enters the vehicle, the humidity enters the activation field 32 associated with the capacitive sensor 24 and causes a disruption to the capacitance, thereby resulting in a raw signal increase as shown by signal 60. The effect of the humidity on the sensor generates a raw signal that rises at a slower rate as compared to an activation motion of the user's finger. Accordingly, by monitoring the rise time of the signal and the amplitude of the signal and comparing the signal to known values of humidity, the condensation or humidity can be sensed with the proximity sensor.

FIG. 8 shows an example of the raw signal for a sensor signal affected by humidity and a look-up table that links the raw signal data to the humidity level based on testing. The data in the look-up table may be generated during testing of the assembly to determine the raw signal count for each of a plurality of known humidity levels. The humidity valves between those value listed in the look-up table may be determined using interpolation. During manufacture, a calibration routine may be performed at a known humidity point to calibrate the bias in the scale. Accordingly, by processing the raw signal data generated by the capacitive sensor, the corresponding humidity may be determined.

Referring to FIG. 9, the state diagram illustrates two modes of operation that are available with the proximity switch and humidity sensing assembly 20. In a first mode, the assembly 20 may operate in a processing user interaction state 72 to detect the touch of a finger on a switch for a switch activation. In a second mode, the assembly 20 may operate in an estimating humidity state to determine the humidity level. It should be appreciated that the processing user interaction mode 72 may operate during a substantial amount of time, while the estimating humidity mode 70 may periodically be operated. It should be appreciated that the processing user interaction mode 72 and estimating humidity mode 70 could be executed simultaneously.

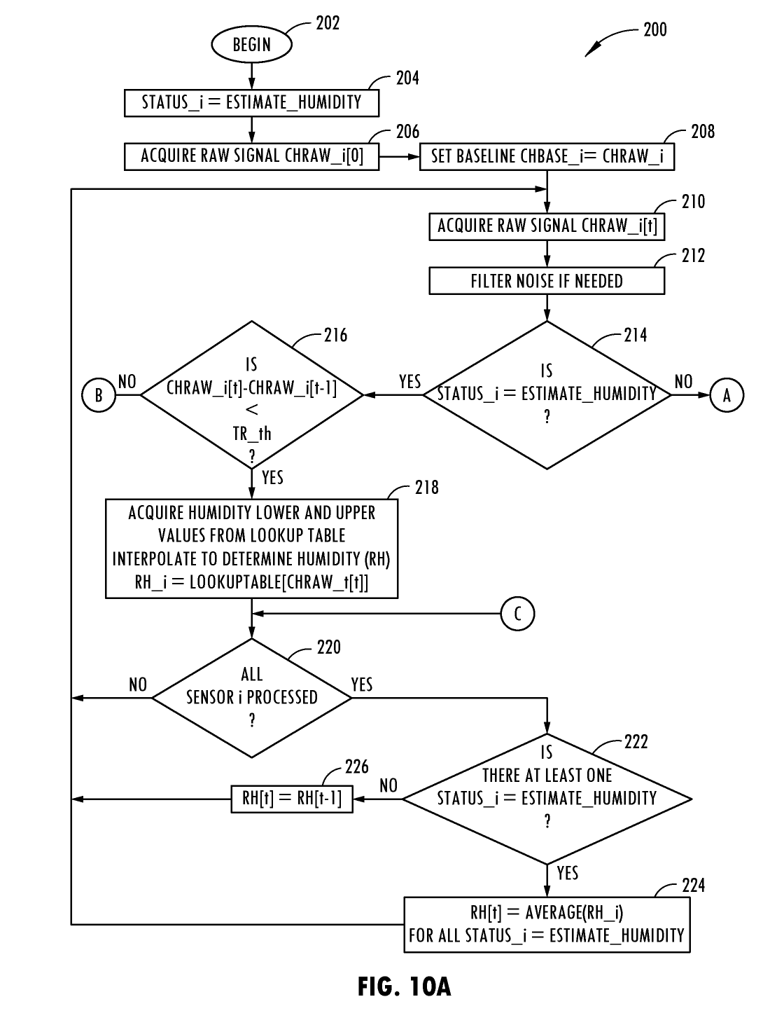

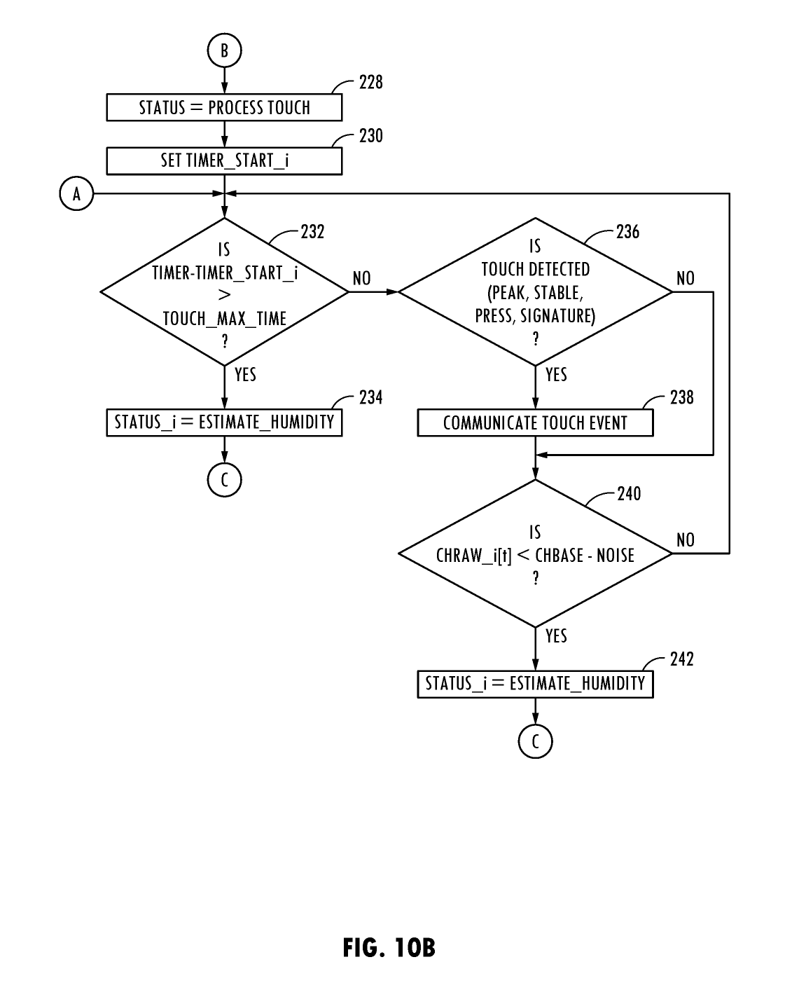

Referring to FIGS. 10A and 10B, a routine 200 for determining switch activation and determining humidity is illustrated, according to one embodiment. The routine 200 begins at step 202 and proceeds to step 204 to set the status state for signal channel (i) to estimate humidity. Next, at step 206 the raw signal CHRAW_i[0] is acquired, and then at step 208 the baseline CHBASE is set equal to the acquired raw signal CHRAW_i. Next, at step 210, the raw signal CHRAWi[t] at the current time (t) is acquired, and noise is filtered in step 212. Proceeding to decision step 214, routine 200 determines if the status_i is set equal to estimate humidity and, if so, proceeds to decision step 216 to determine if the signal is experiencing a slow rise (rate of change in amplitude), that is, if the difference in the current acquired signal i[t] and the previously acquired signal i[t−1] for raw signal CHRAW is less than a threshold TR_th and, if so, proceeds to step 218 to acquire the humidity values for the lower and upper values from the look-up table that define a range containing the value CHRAW[t], and then interpolates to determine the humidity (RH)_i value without that range. Next, at decision step 220, routine 200 determines if all sensors are processed and, if not, returns to step 210. If all sensors i have been processed, routine 200 proceeds to decision step 222 to determine if there is at least one status_i set to estimate humidity and, if not, sets the current humidity value RH([t] equal to the prior humidity value. Otherwise, if there is at least one status_i set to estimate humidity routine 200 determines the humidity value RH[t] equal to an average value of humidity average (RH_i) for the sensors i at decision step 224 before returning to step 210. One or more vehicle modules, such as a climate control system, and use the humidity value RH[t] to perform an action, such as turning on one or more window defoggers to reduce the effect of humidity on the window.

If the signal experiences a fast rise (rate of change in amplitude) at decision step 216, routine 200 proceeds to step 228 to set the status equal to process touch which is the switch touch mode. Next, a timer is set equal to start_i at step 230, and at decision step 232, routine 200 determines if the timer value minus the timer start_i value exceeds or is greater than a touch_max_time value and, if so, sets the status equal to estimate humidity at step 234 before returning to step 220. If the difference in time does not exceed the touch_max_time, routine 200 proceeds to decision step 236 to determine if a touch has been detected, such as by processing the signal for a peak, a stable signal, a press event, or certain touch signature. If a touch is detected, routine 200 proceeds to step 238 to communicate the existence of the touch event. The touch event may trigger activation of the switch to perform a dedicated function. Otherwise, routine 200 proceeds to decision step 240 to determine if value CHRAWi[t] is less than CHBASE minus noise and, if so, sets the status_i equal to estimate humidity in step 242 before returning to step 220. Otherwise, routine 200 returns to step 232.

The proximity sensors may be manufactured using thin film technology which may include printing a conductive ink mixed with a solvent to achieve a desired electrical circuit layout. The printed ink may be formed into a sheet which is cured in a curing process using controlled heating and light/heat strobing to remove the solvent. Variations in existing curing processes may result in residual solvent trapped in the electrical traces which may result in sensors that are sensitive to changes in temperature and humidity. As condensation builds up on a proximity sensor, the raw capacitive signal and the A signal count may change. The condensation buildup may occur in a vehicle, for example, when driving in a rain storm prior to turning on the defroster or when entering the vehicle in a hot, humid summer day and the HVAC fan blows humidity onto the switches. The proximity sensor advantageously detects a user touch activation and humidity using the same sensor. Accordingly, the proximity switch and humidity sensor assembly advantageously provides both proximity sensing for switch activation and humidity measurements.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A proximity switch assembly with humidity sensing, comprising:
a proximity switch comprising a proximity sensor providing an activation field; and
control circuitry monitoring a signal responsive to the activation field, determining a switch activation based on the signal, and determining a humidity value based on the signal.

2. The assembly of claim 1, wherein the control circuitry determines the switch activation based on a rate of change of the signal.

3. The assembly of claim 2, wherein the switch activation is further determined based on an amplitude of the signal exceeding a touch threshold.

4. The assembly of claim 1, wherein the humidity value is determined based on amplitude of the signal.

5. The assembly of claim 4, wherein the humidity value is determined by comparing the amplitude of the signal to known humidity values in a look-up table.

6. The assembly of claim 1, wherein the proximity switch is installed in a vehicle for use by a passenger of the vehicle.

7. The assembly of claim 6, wherein control circuitry controls a window defogger on the vehicle to defog a window based on the humidity value.

8. The assembly of claim 7, wherein the proximity sensor is located near the window.

9. The assembly of claim 1, wherein the proximity switch comprises a capacitive switch comprising one or more capacitive sensors.

10. The assembly of claim 1, wherein the assembly comprises a plurality of proximity switches, each comprising a proximity sensor, wherein the control circuitry determines the humidity value based on signals generated by two or more proximity sensors.

11. The assembly of claim 10, wherein the control circuitry determines the humidity value for each of the two or more proximity sensors and further determines an average humidity based on the humidity values for the two or more proximity sensors.

12. A vehicle proximity switch and humidity sensing assembly, comprising:
a plurality of capacitive switches located on the vehicle, each comprising a capacitive sensor providing an activation field; and
control circuitry monitoring a signal responsive to the activation field, determining a switch activation based on the signal, and determining a humidity value based on the signal.

13. The assembly of claim 12, wherein the control circuitry determines the switch activation based on a rate of change of the signal and an amplitude of the signal exceeding a touch threshold.

14. The assembly of claim 12, wherein the humidity value is determined based on amplitude of the signal, and wherein the humidity value is determined by comparing the signal to known humidity values in a look-up table.

15. The assembly of claim 12, wherein the control circuitry determines the humidity value based on signals generated by two or more capacitive sensors, and wherein the control circuitry determines the humidity value for each of the two or more proximity sensors and further determines an average humidity based on the humidity values for the two or more proximity sensors.

16. A method of detecting switch activation and humidity with a proximity switch, comprising:
generating an activation field with a proximity sensor;
monitoring amplitude of a signal generated in response to the activation field;
determining an activation of the switch based on the signal; and
determining a humidity value based on the signal.

17. The method of claim 16, wherein the proximity switch is installed in a vehicle for use by a passenger of the vehicle.

18. The method of claim 16, wherein the proximity switch comprises a capacitive switch comprising one or more capacitive sensors.

19. The method of claim 16, wherein activation of the switch is determined based on the amplitude and a rate of change of the signal.

20. The method of claim 16, wherein the humidity value is determined based on amplitude of the signal compared to known humidity values in a look-up table.
